(19) United States
(12) Patent Application Publication
(10) Pub. No.: US 2020/0383045 A1
(43) Pub. Date: Dec. 3, 2020

(54) ACCESS POINT SELECTION FROM A SET OF CANDIDATES DURING CONNECTION WITH A STATION

(71) Applicant: QUALCOMM Incorporated, San Diego, CA (US)

(72) Inventors: Deepak Jindal Kumar, Hyderabad (IN); Manish Kothari, Cupertino, CA (US); Sudhanshu Singh, Hyderabad (IN); Santhi Swaroop Golti, Hyderabad (IN); Sunil Dutt Undekari, Hyderabad (IN)

(21) Appl. No.: 16/427,130

(22) Filed: May 30, 2019

(51) Int. Cl. H04W 48/20; H04W 48/06; H04W 48/14; H04W 72/08

(52) U.S. Cl. CPC H04W 48/20; H04W 48/06; H04W 76/10; H04W 72/085; H04W 48/14

(57) ABSTRACT

Methods, systems, and devices for wireless communications are described. Wireless stations (STAs) may be within the coverage areas of several of access points (APs). In such cases, STAs may detect some set of candidate APs for possible connection, and the STAs may perform some selection procedure to select an AP for connection. For example, a STA may score or rank available APs (e.g., APs within the set of candidate APs), and the STA may sort the candidate APs into different bins (e.g., categories) based on their respective scores (e.g., based on each AP's candidate score). Each bin may thus include one or more APs associated with some scoring range. A STA may then randomly (e.g., or pseudo-randomly) select an AP from the bin associated with a highest range of candidate scores, and the STA may connect to the selected AP.

### BACKGROUND

The following relates generally to wireless communications, and more specifically to access point (AP) selection from a set of candidates during connection with a station (STA).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include AP that may communicate with one or more STAs or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. The downlink (or forward link) may refer to the communication link from the AP to the station, and the uplink (or reverse link) may refer to the communication link from the station to the AP.

A wireless device (e.g., a STA) may communicate with a network upon establishing a connection and associating with an AP. A STA may, in some cases, select an AP for association, and connect to the selected AP. For example, a STA may select an AP for connection based on multiple parameters used to rank or score some set of available APs (e.g., from a set of candidate APs). In some cases, connection procedures may result in association delays or inefficient connections (e.g., which may result in connection latency, inefficient usage of available resources, etc.).

### SUMMARY

The described techniques relate to improved methods, systems, devices, or apparatuses that support access point (AP) selection from a set of candidates during connection with a station (STA). Generally, the described techniques provide for improved AP selection and thus more efficient STA connection procedures. For example, a STA may score or rank available APs (e.g., APs within some set of candidate APs), and may sort the candidate APs into different bins (e.g., categories) based on their respective scores. Each bin may thus include one or more APs associated with some scoring range. A STA may randomly select an AP from one or more APs in the highest ranked bin. As such, several

STAs in a same location (e.g., or connecting to a same set of candidate APs) may randomize suitable AP selection to avoid selection of a same AP by multiple STAs. In some cases, such random selection of an AP from one or more APs in the highest ranked bin may result in a STA selecting a different AP for a second connection procedure that an AP selected for a previous connection procedure (e.g., in cases where the AP selected for the previous connection procedure resulted in some inefficient connection condition).

In some examples, if there are issues with an AP (e.g., if some adverse connection condition resulted from connection to the AP), the AP score may be penalized (e.g., and dropped into a lower bin) for some configured amount of time. The STA may then randomly select a new AP from the highest ranked bin, and the highest ranked bin may no longer include the AP previously associated with the poor connection condition. That is, in cases where a STA disconnects from an AP due to some connectivity condition (e.g., if the AP is overloaded due to connections with other neighbor STAs, if the connection was associated with data stalls or poor data connectivity, etc.) the score of the AP (e.g., the AP's candidate score) may be updated such that the AP is removed from the bin used for AP selection (e.g., removed from the highest ranked bin). In some cases, the updated score (e.g., the penalized candidate score) may be associated with a penalization score timer, such that upon expiration of the penalization score timer the score of the AP may be recalculated, may be set back to the original candidate score, etc. In some examples, repeated occurrence of poor connection conditions with a same AP (e.g., second or third connectivity issues with a same AP) may result in the AP being blacklisted (e.g., scored or placed into a low rank or blacklist bin, for some blacklisting time duration, until the STA identifies the AP has been reset, etc.).

A method of wireless communication at a wireless STA is described. The method may include detecting one or more APs based on a scanning procedure, and sorting the one or more detected APs into one or more bins based on a candidate score of each AP of the one or more APs, where each bin of the one or more bins is associated with a range of candidate scores. The method may further include selecting a first AP randomly from a first bin based on the sorting, where the first bin is associated with a highest range of candidate scores, and connecting to the first AP based on the selecting.

An apparatus for wireless communication at a wireless STA is described. The apparatus may include a processor, memory in electronic communication with the processor, and instructions stored in the memory. The instructions may be executable by the processor to cause the apparatus to detect one or more APs based on a scanning procedure, and sort the one or more detected APs into one or more bins based on a candidate score of each AP of the one or more APs, where each bin of the one or more bins is associated with a range of candidate scores. The instructions may be executable by the processor to further cause the apparatus to select a first AP randomly from a first bin based on the sorting, where the first bin is associated with a highest range of candidate scores, and connect to the first AP based on the selecting.

Another apparatus for wireless communication at a wireless STA is described. The apparatus may include means for detecting one or more APs based on a scanning procedure, sorting the one or more detected APs into one or more bins based on a candidate score of each AP of the one or more APs, where each bin of the one or more bins is associated with a range of candidate scores, selecting a first AP randomly from a first bin based on the sorting, where the first bin is associated with a highest range of candidate scores, and connecting to the first AP based on the selecting.

A non-transitory computer-readable medium storing code for wireless communication at a wireless STA is described. The code may include instructions executable by a processor to detect one or more APs based on a scanning procedure, sort the one or more detected APs into one or more bins based on a candidate score of each AP of the one or more APs, where each bin of the one or more bins is associated with a range of candidate scores, select a first AP randomly from a first bin based on the sorting, where the first bin is associated with a highest range of candidate scores, and connect to the first AP based on the selecting.

Some examples of the method, apparatuses, and non-transitory computer-readable medium described herein may further include operations, features, means, or instructions for disconnecting from the first AP based on a connectivity condition. Some examples of the method, apparatuses, and non-transitory computer-readable medium described herein may further include operations, features, means, or instructions for selecting a second AP randomly from the first bin based on the connectivity condition, and connecting to the second AP based on the selecting.

Some examples of the method, apparatuses, and non-transitory computer-readable medium described herein may further include operations, features, means, or instructions for updating the candidate score for the first AP based on the connectivity condition, and sorting the first AP into a second bin based on the updated candidate score, where the second bin may be associated with a lower range of candidate scores relative to the first bin. Some examples of the method, apparatuses, and non-transitory computer-readable medium described herein may further include operations, features, means, or instructions for determining a penalization score timer may have expired, and sorting the first AP into the first bin based on the candidate score for the first AP and the determination that the penalization score timer may have expired. Some examples of the method, apparatuses, and non-transitory computer-readable medium described herein may further include operations, features, means, or instructions for determining the penalization score timer may have expired, and sorting the first AP into a third bin based on the determination that the penalization score timer may have expired, where the third bin may be associated with a higher range of candidate scores relative to the second bin.

Some examples of the method, apparatuses, and non-transitory computer-readable medium described herein may further include operations, features, means, or instructions for determining a second connectivity condition with the first AP, and determining to blacklist the first AP for a blacklisting time duration based on the determined second connectivity condition. Some examples of the method, apparatuses, and non-transitory computer-readable medium described herein may further include operations, features, means, or instructions for determining the blacklisting time duration may have expired, and sorting the first AP into the first bin based on the candidate score for the first AP and the determination that the blacklisting time duration may have expired. Some examples of the method, apparatuses, and non-transitory computer-readable medium described herein may further include operations, features, means, or instructions for determining the blacklisting time duration may have expired, and sorting the first AP into a third bin based on the determination that the blacklisting time duration may have expired, where the third bin may be associated with a higher range of candidate scores relative to the second bin.

Some examples of the method, apparatuses, and non-transitory computer-readable medium described herein may further include operations, features, means, or instructions for updating the candidate score for the first AP, and sorting the first AP from a second bin into the first bin based on the updated candidate score, where the second bin may be associated with a lower range of candidate scores relative to the first bin.

### BRIEF DESCRIPTION OF THE DRAWINGS

FIG. 1 illustrates an example of a system for wireless communications that supports access point (AP) selection from a set of candidates during connection with a station (STA) in accordance with aspects of the present disclosure.

FIG. 2 illustrates an example of a process flow that supports AP selection from a set of candidates during connection with a STA in accordance with aspects of the present disclosure.

FIGS. 3 and 4 show block diagrams of devices that support AP selection from a set of candidates during connection with a STA in accordance with aspects of the present disclosure.

FIG. 5 shows a block diagram of a communications manager that supports AP selection from a set of candidates during connection with a STA in accordance with aspects of the present disclosure.

FIG. 6 shows a diagram of a system including a device that supports AP selection from a set of candidates during connection with a STA in accordance with aspects of the present disclosure.

FIGS. 7 through 9 show flowcharts illustrating methods that support AP selection from a set of candidates during connection with a STA in accordance with aspects of the present disclosure.

### DETAILED DESCRIPTION

A wireless device (e.g., a wireless station (STA)) perform scanning procedures to detect one or more access points (APs) to which the STA may connect to. In some cases, the STA may be within the coverage areas of several of APs. In such cases, the STA may detect some set of candidate APs, and it may be beneficial for the STA to consider which AP of the set of candidate APs the STA should connect to. For example, a STA may perform some selection procedure to select an AP for connection. In some cases, such selection procedures may consider channel conditions (e.g., received signal strength indicator (RSSI)), bands, a number of spatial streams (NSS), data rates, channel load metrics, association performance metrics, etc. associated with each AP in the set of candidate APs. For example, in some cases, the STA may rank or score each AP (e.g., may determine a candidate score for each AP), and may select a highest scored AP for connection.

However, in some cases, a top ranked (e.g., a highest scoring) AP may be selected in scenarios where the top ranked AP may not be suitable (e.g., or most efficient) for a connection. For example, in scenarios where several devices in a same location (e.g., scenarios where several STAs may be connecting to a same set of candidate APs), use of the same scoring methods may result in some or all of the several devices similarly selecting and overloading the same AP. Additionally or alternatively, if a STA has previously disconnected from a top ranked AP due to connectivity issues (e.g., due to overloading of the AP, data stalls or poor data connectivity with the AP, etc.), the STA may continue to reselect the top ranked AP for further reconnection attempts (e.g., which may result in additional or prolonged connectivity issues).

According to the techniques described herein, a STA may score or rank available APs (e.g., APs within some set of candidate APs), and may sort the candidate APs into different bins (e.g., categories) based on their respective scores. Each bin may thus include one or more APs associated with some scoring range. A STA may then randomly (e.g., or pseudo-randomly) select an AP from one or more APs in the highest ranked bin (e.g., such that several STAs in a same location, or several STAs connecting to a same set of candidate APs, may randomize suitable AP selection to avoid selection of a same AP). Such random selection of suitable APs (e.g., random selection of an AP with a suitable candidate score from a highest ranked bin) may thus reduce overloading of one or more top ranked APs, as several STAs may randomly select suitable APs (e.g., rather than several STAs all similarly selecting the one or more top ranked APs). Further, in scenarios where a STA disconnects from a previously selected AP (e.g., due to connectivity issues), such random selection of suitable APs may reduce the likelihood that a STA continuously selects the previously selected AP for connection.

In some examples, if inefficient connection conditions (e.g., AP overloading, data stalls, association delay, etc.) are associated with some AP, the AP's candidate score may be updated (e.g., the score of the AP may be penalized), and the AP may be sorted into a lower bin (e.g., a bin associated with a lower range of candidate scores) for some configured amount of time. The STA may then randomly select a new suitable AP from the highest ranked bin (e.g., which may no longer include the AP associated with poor connection conditions), and subsequently connect to the new AP. In some cases, upon expiration of a penalization score timer the score of the AP may be recalculated, may be set back to the AP's original candidate score, etc. (e.g., such that in cases where the penalized AP may later provide improved connection, the AP may be selected again for connection). In some examples, repeated occurrence of poor connection conditions with a same AP (e.g., second or third connectivity issues with a same AP after the AP has already been penalized) may result in the AP being blacklisted (e.g., scored or placed into a low rank or blacklist bin, for some blacklisting time duration, until the STA identifies the AP has been reset, etc.).

Aspects of the disclosure are initially described in the context of a wireless communications system. An example process flow for implementing the described techniques are then discussed. Aspects of the disclosure are further illustrated by and described with reference to apparatus diagrams, system diagrams, and flowcharts that relate to AP selection from a set of candidates during connection with a STA

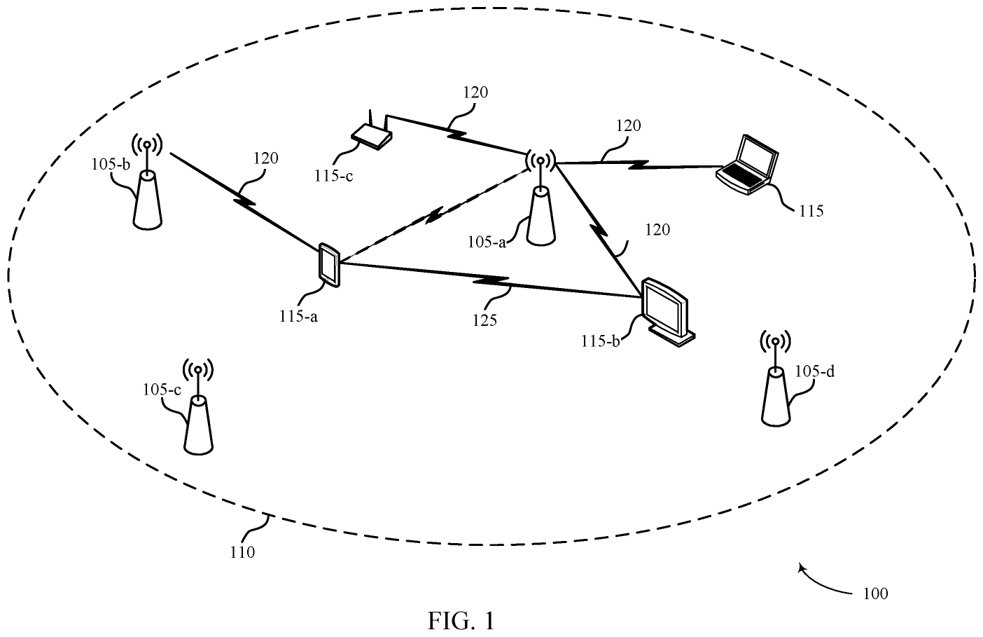

FIG. 1 illustrates a wireless local area network (WLAN) 100 (also known as a Wi-Fi network) configured in accordance with various aspects of the present disclosure. The WLAN 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a BSS or an ESS. The various STAs 115 in the network are able to communicate with one another through the AP 105. Also shown is a coverage area 110 of the AP 105, which may represent a BSA of the WLAN 100. An extended network station (not shown) associated with the WLAN 100 may be connected to a wired or wireless distribution system that may allow multiple APs 105 to be connected in an ESS.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of an RTS packet transmitted by a sending STA 115 (or AP 105) and a CTS packet transmitted by the receiving STA 115 (or AP 105). This may alert other devices within range of the sender and receiver not to transmit for the duration of the primary transmission. Thus, RTS/CTS may help mitigate a hidden node problem.

As discussed herein, STAs 115 may be within the coverage areas of several of APs 105. In such cases, STAs 115 may detect some set of candidate APs 105 for possible connection, and the STAs 115 perform some selection procedure to select an AP 105 for connection. A STA 115 may score or rank available APs 105 (e.g., APs within some set of candidate APs), and may sort the candidate APs 105 into different bins (e.g., categories) based on their respective scores (e.g., based on each AP 105's candidate score). Each bin may thus include one or more APs 105 associated with some scoring range. A STA 115 may then randomly (e.g., or pseudo-randomly) select an AP 105 from the bin associated with a highest range of candidate scores, and connect to the AP 105 based on the selecting.

In some examples, WLAN 100 may include STA 115-a, STA 115-b, STA 115-c, AP 105-a, AP 105-b, AP 105-c, and AP 105-d. WLAN 100 may illustrate STA 115-a performing techniques described herein for AP selection from a set of candidates (e.g., from AP 105-a, AP 105-b, AP 105-c, and AP 105-d) during connection. According to the techniques described herein, STA 115-a may score or rank available APs (e.g., APs within some set of candidate APs, such as APs with a candidate set including AP 105-a, AP 105-b, AP 105-c, and AP 105-d), and STA 115-a may sort the candidate APs into different bins (e.g., categories) based on their respective scores. Each bin (e.g., which may be used interchangeably with bucket, category, etc.) may thus include one or more APs associated with some scoring range. For instance, in the example of FIG. 1, AP 105-a and AP 105-b may each be associated with a first bin (e.g., a highest bin associated with a highest range of candidate scores), and AP 105-c and AP 105-d may be associated with a second bin (e.g., a second bin associated with a lower range of candidate scores). In such an example, AP 105-a and AP 105-b may be referred to as suitable APs (e.g., as either of AP 105-a and AP 105-b may be suitable candidates for efficient connection for STA 115-a).

STA 115-a may then randomly (e.g., or pseudo-randomly) select an AP from one or more APs in the highest ranked bin. As such, that several STAs in a same location, or several STAs connecting to a same set of candidate APs (e.g., STA 115-a, STA 115-b, and STA 115-c) may randomize suitable AP selection to avoid selection of a same AP. For example, in cases where AP 105-a is associated with a highest candidate score (e.g., or in cases where AP 105-a and AP 105-b are associated with a same highest candidate score, but AP 105-a is associated with the lowest channel number) STA 115-a, STA 115-b, and STA 115-c may all otherwise (e.g., without using the techniques described herein) often select the same AP 105-a. Such may result in overloading of AP 105-a, even though AP 105-b may be a suitable AP for connection. Such random selection of suitable APs (e.g., random selection of an AP with a suitable candidate score from a highest ranked bin) may thus reduce overloading of AP 105-a, as STA 115-a, STA 115-b, and STA 115-c may randomly select from suitable AP 105-a and suitable AP 105-b (e.g., rather than STA 115-a, STA 115-b, and STA 115-c all similarly selecting the AP 105-a). Further, in scenarios where a STA (e.g., STA 115-a) disconnects from a previously selected AP (e.g., AP 105-a) due to connectivity issues, such random selection of suitable APs may reduce the likelihood that STA 115-a continuously selects the previously selected AP 105-a for connection (e.g., as STA 115-a may randomly select suitable AP 105-b upon subsequent connection procedures).

In some examples, if inefficient connection conditions (e.g., AP overloading, data stalls, association delay, etc.) are associated with some AP (e.g., AP 105-a), the AP 105-a's candidate score may be updated (e.g., the score of the AP 105-a may be penalized), and the AP 105-a may be sorted into a lower bin (e.g., a bin associated with a lower range of candidate scores) for some configured amount of time. The STA 115-a may then randomly select a new suitable AP 105-b from the highest ranked bin (e.g., which may no longer include the AP 105-a associated with poor connection conditions), and subsequently connect to the new AP 105-b. In some cases, upon expiration of a penalization score timer the score of the AP 105-a may be recalculated, may be set back to the AP 105-a's original candidate score, etc. (e.g., such that in cases where the penalized AP 105-a may later provide improved connection, the AP 105-a may be selected again for connection). In some examples, repeated occurrence of poor connection conditions with a same AP 105-a (e.g., second or third connectivity issues with a same AP 105-a after the AP 105-a has already been penalized) may result in the AP 105-a being blacklisted (e.g., scored or placed into a low rank or blacklist bin, for some blacklisting time duration, until the STA 115-a identifies the AP 105-a has been reset, etc.).

A STA 115 may perform a scan to discover (e.g., detect) APs to connect to within a region. The STA 115 may scan one or more channels supported by the STA 115, and, in some cases, the scanning may be conducted in some order which may be configured at the STA 115 or fixed at the time of implementation. For example, a STA 115 operating on 2.4 gigahertz (GHz) may scan channel 1 first, then channel 2, etc. Once the STA 115 has completed the scan, STA 115 may determine which candidate AP to connect to (e.g., from the set of candidate APs). Once the STA 115 determines which AP to connect to, the STA may connect the that selected AP.

A STA 115 may determine which candidate AP to connect to by scoring candidate APs based on different connectivity parameters. In some cases, the candidate AP with the highest or best score may be selected by STA 115 as the candidate AP to connect to. As an example, APs may be sorted based on the order in which scanning was done (e.g., and the order in which the scanning is performed may be in order of channel number). In some cases, two APs may be determined to have the same score, but one of the APs may be on channel 1 and the other AP may be on channel 11. In such cases, the AP on channel 1 may be sorted as the highest AP, even if it has the same score as the AP on channel 11.

Multiple STAs 115 is a region may be configured with the same implementation protocol to sort APs in a certain order and may select a candidate AP based on the same parameters. In such cases, one or more STAs 115 in an area may attempt to connect to the same AP (e.g., since the one or more STAs 115 may sort that same AP as the highest scored AP).

Certain connectivity parameters may be considered when calculating scores of candidate APs (e.g., when calculating candidate scores for each AP). These connectivity or scoring parameters may include received signal strength indicator (RSSI), frequency band, NSS, high throughput/very high throughput (HT/VHT) capability, high efficiency (HE) capability, BSS load, beamformer capability, physical (PHY) mode (e.g., 11b, 11a, 11g, 11n, 11ac, 11ax) and other connectivity parameters.

For example, Table 1 may provide an example of data collected for a set of APs 105 within a region (e.g., within an office). Twelve APs 105 (e.g., which in some cases may include AP 105-a, AP 105-b, AP 105-c, and AP 105-d) may be set up within the office. A set of STAs 115 (e.g., which may include STA 115-a. STA 115-b, and STA 115-c) may perform searches (e.g., scanning procedures) to detect APs 105. For example, STA 115-a may be configured to find an AP to connect to from within a set of detectable APs 105 (e.g., 12 Hydra APs). Some of the APs 105 within the region may be configured on different channels/frequency bands. As shown in Table 1, multiple APs 105 may have a same candidate score or BSSSCORE (e.g., a STA 115 may calculate a same candidate score for one or more candidate APs 105 of the set of candidate APs detected during the scanning procedure). As the table shows, STA 115-a may select the first AP 105 in the table (e.g., AP 105-a) to connect to, because AP 105-a may have the highest score and may be associated with the lowest channel number. However, other STAs 115 (e.g., STAs 115-b, STA 115-c) may also have the same scoring and candidate selection logic, and may thus sort and select the AP 105-a in the same way. Thus, many other STAs 115 may also determine to select AP 105-a to connect to.

When several STAs 115 within the same area select and connect to the same AP, multiple issues may occur. These issues may include overloading the AP 105, which may lead to slow connectivity and may result in poor user experience. The issues can also include data stalling and poor data connectivity, which may cause STAs 115 to disconnect and conduct a new scan for APs. However, this new scan may in some cases result in the same AP 105 being selected again, as the connectivity parameters used to score the AP 105 may not have changed. In some cases, the candidate selection algorithm at the STA 115 may be fixed, and thus the STA 115 may not be able to change the AP selection process based on connectivity issues with a certain AP 105. Other APs 105 within the region may have equal or slightly lower scores (e.g., other APs may otherwise be suitable for connection), but may not be selected for connection because they are on a higher numbered channel, or because the

AP 105 is not the highest ranked AP 105. These other APs may be better candidate APs when considering connectivity issues due to overloading the primarily selected AP 105.

TABLE 1

| BSS ID | Channel | RSSI | BSS SCORE | Bin |
|---|---|---|---|---|
| 00:c1:64:e8:60:df | 36 | −43 | 3904 | Bin 1 |
| 00:c1:64:f2:f8:00 | 149 | −47 | 3904 | |
| 00:c1:64:f2:d6:e0 | 6 | −51 | 3029 | Bin 2 |
| 00:c1:64:b6:91:20 | 1 | −55 | 3029 | |
| 00:c1:64:ff:fd:e0 | 11 | −66 | 2729 | Bin 3 |
| 00:c1:64:f2:d7:b0 | 6 | −66 | 2729 | |
| 00:c1:64:e8:5e:20 | 1 | −80 | 1180 | Bin 4 |
| 00:c1:64:9d:c5:e0 | 11 | −86 | 800 | Bin 5 |
| 00:42:68:78:cd:a0 | 1 | −87 | 800 | |
| 00:c1:64:e8:5f:10 | 11 | −83 | 800 | |
| 00:c1:64:e8:5f:1f | 56 | −91 | 650 | Bin 6 |
| 00:c1:64:ff:e9:ef | 36 | −91 | 650 | |

According to the described techniques, once STA 115-a completes scanning and sorting of the APs 105, STA 115-a may sort APs 105 into bins of APs 105 with the same or similar scores (e.g., Bin 1, 2, 3, 4, 5, and 6, as shown in Table 1). After completing the sorting, STA 115-a may randomly pick an AP 105 (e.g., AP 105-a) from within a bin (e.g., from within Bin 1, which may be referred to as a highest bin or a bin with a highest range of candidate scores), rather than always picking the top AP 105. If STA 115-a experiences connectivity issues with the selected AP 105 (e.g., AP 105-a), it may disconnect and randomly pick another AP 105 (e.g., AP 105-b) to connect to within the same bin (e.g., Bin 1). In this example, when multiple STAs 115 operate according to this procedure, not all of the STAs 115 may select the same AP 105 to connect to (e.g., due to the random selection of APs from the first bin), which may decrease instances of connectivity issues when many STAs 115 may otherwise connect to the same AP 105.

In some cases, there may only be one AP 105 (e.g., AP 105-a) in the highest ranked score bin (e.g., Bin 1). In this case, STA 115-a may still connect to AP 105-a at first. If STA 115-a experiences connectivity issues (e.g., detecting a data stall) with AP 105-a, STA 115-a may disconnect from AP 105-a. STA 115-a may also penalize AP 105-a by changing the score corresponding to AP 105-a (e.g., updating the candidate score of AP 105-a), so that AP 105-a moves to a lower score bin. Then, STA 115-a may randomly select an AP 105 from the next bin of scores, as that bin may now have the highest ranked APs 105 due to the penalization of previously highest ranked AP 105-a. The score penalization of AP 105-a may last for a configured period of time (e.g., for some penalization score timer), which may allow for, if there was a temporary problem with the AP 105-a, that AP 105-a may be chosen again for a later connection (e.g., if at a later time it is more efficient for the STA to connect to the AP 105-a). In some cases, if data stall is detected a repeated number of times with particular AP, then the AP may be blacklisted for some configured amount of time (e.g., for some blacklisting time duration).

As such, STAs may identify and acquire information about existing APs in surrounding area (e.g., via Active or Passive scanning or identification). In some cases, STAs may also periodically trigger Scanning for Roaming and try to find a better AP. The scanning may return one or more potential APs (e.g., a set M={i=1, 2, . . . , N}) with corresponding score {S₁, S₂, . . . , S_{N}} where M={Mᵢ set of APs with Score Sᵢ}. For selection, the STA may make a list of bins of APs based upon the range of the score starting from the max score: B⊆M where Sᵢ, 0≤max {M}−Sᵢ≤ScoreRange}, where max {M} is a maximum score of the AP from candidate set {M}. If B has only one entry, then the STA may choose the AP with the best score. Otherwise (e.g., else), the STA may randomly (e.g., or pseudo-randomly) choose an AP from the bin B (e.g., from the first bin).

In some cases, once data stall or other poor connection condition is detected with connected AP from bin B, the STA may make a bin of APs:

B⊆M where {Sᵢ ∈ {M}, 0≤max {M}−Sᵢ <ScoreRange} and

B1⊆{M−B} where {Sᵢ ∈{M−B}, 0≤max {M−B}−Sᵢ≤ScoreRange}.

If B has only one entry (e.g., if bin B includes a single AP), the STA may randomly choose an AP from bin B1. Otherwise (e.g., else) the STA may randomly choose an AP from bin B. As such, once an AP identifies a problem (e.g., a connection condition) and disconnects from an AP, the AP may be penalized and a new bin B1 may be established (e.g., where B1 is a subset of the bin M−B.

In some cases, the magnitude of the penalization (e.g., the amount an AP candidate score is penalized) may depend on the way in which the STA determines the bins during the selection procedure. For example, a candidate score penalization may be some percentage of the original candidate score, where the percentage is based on the incrementation of the bins (e.g., such that the percentage is chosen to ensure a candidate score penalization will drop the penalized AP into a lower bin). For example, if some selection procedure increments bins into candidate scores of a max ScoreRange 100, 150, 200, 250, 300, and 350 (e.g., each bin increments 50), a penalization percentage of at least 15% may be determined (e.g., as a maximum candidate score of 350 in a first bin would be dropped to a second bin if penalized, as 350*(15%)=50.2, and a penalization of 50.2 would drop the AP into a lower bin due to the ScoreRange=50 incrementation).

In some examples, repeated occurrence of poor connection conditions with a same AP 105-a (e.g., second or third connectivity issues with a same AP 105-a after the AP 105-a has already been penalized) may result in the AP 105-a being blacklisted (e.g., scored or placed into a low rank or blacklist bin, for some blacklisting time duration, until the STA 115-a identifies the AP 105-a has been reset, etc.). For example, in some cases, a blacklisted AP 105-a may be blacklisted for some blacklisting time duration (e.g., which may be some time duration longer than the penalization score timer). Upon expiration of the blacklisting time duration, the score of the AP 105-a may be recalculated, may be set back to the AP 105-a's original candidate score, etc. (e.g., such that in cases where the blacklisted AP 105-a has been reset, the AP 105-a may be selected again for connection). In some cases, the blacklisted AP 105-a may be blacklisted until the STA 115-a identifies that the blacklisted AP 105-a has been reset (e.g., via AP 105-a timestamp monitoring by STA 115-a). For example, if the blacklisted AP 105-a is reset (e.g., by the network) from some connectivity condition, the STA 115-a may detect that the blacklisted AP 105-a has been reset (e.g., when the blacklisted AP 105-a gets reset, a timestamp that has also been reset may be sent by the AP 105-a, when the AP 105-a resets the timestamp, the STA 115-a may detect the reset timestamp and remove the AP 105-a from the blacklist).

According to the techniques described herein, STAs may more efficiently select an AP for connection in wireless communications systems employing multiple APs and/or multiple STAs (e.g., STAs may randomly select a suitable AP from a first bin, which may improve connections due to, for example, reduced data stalling, greater throughput, reduced association delay, etc.). Such techniques may reduce occurrence of overloaded APs (e.g., which may otherwise result in more time for a STA to associate with the AP compared to other suitable APs with which the STA may communicate). In some cases, such reduced poor connection conditions, association delays, etc. may result in more efficient use of resources (e.g., time and throughput) that STAs may benefit from (e.g., as other suitable APs may be selected to more efficiently or more fully balance available resources, such as bandwidth).

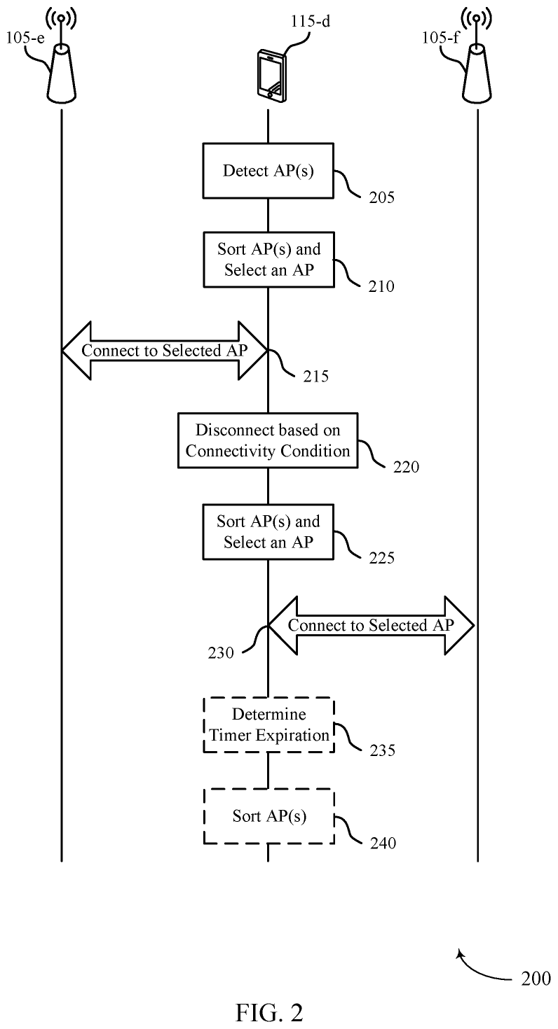

FIG. 2 illustrates an example of a process flow 200 that supports AP selection from a set of candidates during connection with a STA in accordance with aspects of the present disclosure. In some examples, process flow 200 may implement aspects of WLAN 100. Further, process flow 200 may be implemented by a STA 115-d, AP 105-e, and AP 105-f, which may be examples of a STA 115 and an AP 105 described with reference to FIG. 1. In the following description of the process flow 200, the operations between STA 115-d, AP 105-e, and AP 105-f may be transmitted in a different order than the order shown, or the operations performed by STA 115-d, AP 105-e, and AP 105-f may be performed in different orders or at different times. Certain operations may also be left out of the process flow 200, or other operations may be added to the process flow 200. It is to be understood that while STA 115-d, AP 105-e, and AP 105-f are shown performing a number of the operations of process flow 200, any wireless device may perform the operations shown.

At 205, STA 115-d may detect one or more APs (e.g., AP 105-e and AP 105-f) based on a scanning procedure (e.g., STA 115-d may perform a scanning procedure and detect AP 105-e and AP 105-f).

At 210, STA 115-d may sort the one or more detected APs into one or more bins based on a candidate score of each AP of the one or more APs. APs may be ranked according to candidate scores (e.g., which may refer to a score of an AP for presumed connection performance). For example, a candidate score may be determined or calculated by a STA based on channel conditions or RSSI, one or more operating bands, NSS, HT/VHT capability, HE capability, channel load metrics (e.g., BSS load), AP beamforming capability, supported PHY modes (e.g., 11b/11a/11g/11n/11ac/11ax), association performance metrics, or other parameters or conditions for STA and AP connection performance. In some cases, a candidate score may be determined or calculated based on some weighted combination of such factors.

STA 115-d may thus sort the one or more detected APs into one or more bins based on such candidate scores for one or more of the detected APs. Each bin of the one or more bins may be associated with a range of candidate scores (e.g., where a highest bin may be associated with a highest range of candidate scores, and the highest bin may thus include suitable APs for connection to the STA 115-d). In the present example, both AP 105-e and AP 105-f may be associated with the highest bin (e.g., and other APs, which may or may not be detected at 205, may be associated with lower bins). The STA 115-d may then select a first AP (e.g., AP 105-e) randomly from a first bin based on the sorting, where the first bin (e.g., the highest bin) may be associated with a highest range of candidate scores (e.g., the first bin may include one or more APs that have been scored or ranked in some highest or suitable range by the STA 115-d).

At 215, STA 115-d may connect to AP 105-e based on the selecting (e.g., based on randomly selecting AP 105-e from the highest bin).

At 220, STA 115-d may disconnect from AP 105-e based on a connectivity condition (e.g., based on a connectivity issue, a poor connectivity condition, etc.). For example, in some cases, the connectivity condition may refer to AP 105-e being overloaded, or too high or undesirable channel load metrics associated with AP 105-e (e.g., the connectivity condition may refer a high total channel load condition, a high channel load condition due to BSS and/or the number of associated or active STAs on a channel between the AP 105-e and the STA 115-d, etc.). In some cases, the connectivity condition may refer to an association delay condition, a low throughput condition, a poor channel condition, a data stall condition, a poor data connectivity condition, a non-responsive AP condition, etc.

At 225, STA 115-d randomly select an AP from the highest bin (e.g., based on the disconnecting at 220). In some examples (e.g., due to the random or pseudo-random nature of the selecting), the STA 115-d may select AP 105-f from the first bin. In some examples, the STA 115-d may update the candidate score for the AP 105-e based on the connectivity condition and/or disconnection at 220, and the STA 115-d may sort the AP 105-e into a second bin (e.g., a bin lower than the first bin) based on the updated candidate score (e.g., such that the AP 105-f is selected based on the AP 105-e no longer being sorted into the first bin due to the updated or penalized candidate score for AP 105-e).

At 230, STA 115-d may connect to the AP 105-f based on the selecting at 225 (e.g., based on randomly selecting AP 105-e from the highest bin, based on randomly selecting AP 105-e from the highest bin that may not include AP 105-e due to penalization of AP 105-e, etc.).

In some cases (e.g., in cases where AP 105-e is penalized), at 235, STA 115-d may determine a penalization score timer has expired. In such cases, at 240, STA 115-d may recalculate a score of AP 105-e, may be reset the score of AP 105-e back to the original candidate score of AP 105-e, etc. (e.g., such that in cases where the penalized AP 105-e may later provide improved connection, the AP 105-e may be selected again for connection at a later time). As discussed herein, in some examples, repeated occurrence of poor connection conditions with a same AP 105-e (e.g., second or third connectivity issues with AP 105-e after the AP 105-e has already been penalized at 225) may result in the AP 105-e being blacklisted (e.g., scored or placed into a low rank or blacklist bin for some blacklisting time duration, scored or placed into a low rank or blacklist bin until the STA 115-d identifies the AP 105-e has been reset, etc.).

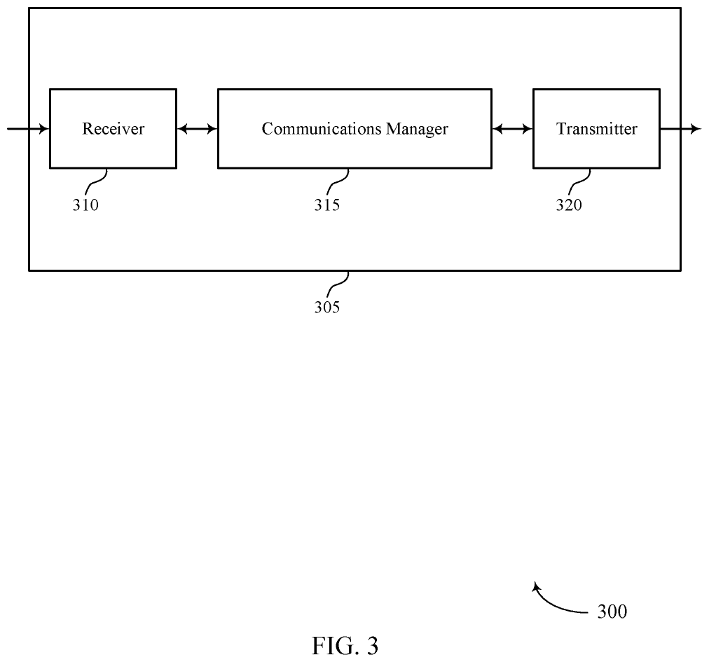

FIG. 3 shows a block diagram 300 of a device 305 that supports AP selection from a set of candidates during connection with a STA in accordance with aspects of the present disclosure. The device 305 may be an example of aspects of a STA as described herein. The device 305 may include a receiver 310, a communications manager 315, and a transmitter 320. The device 305 may also include a processor. Each of these components may be in communication with one another (e.g., via one or more buses).

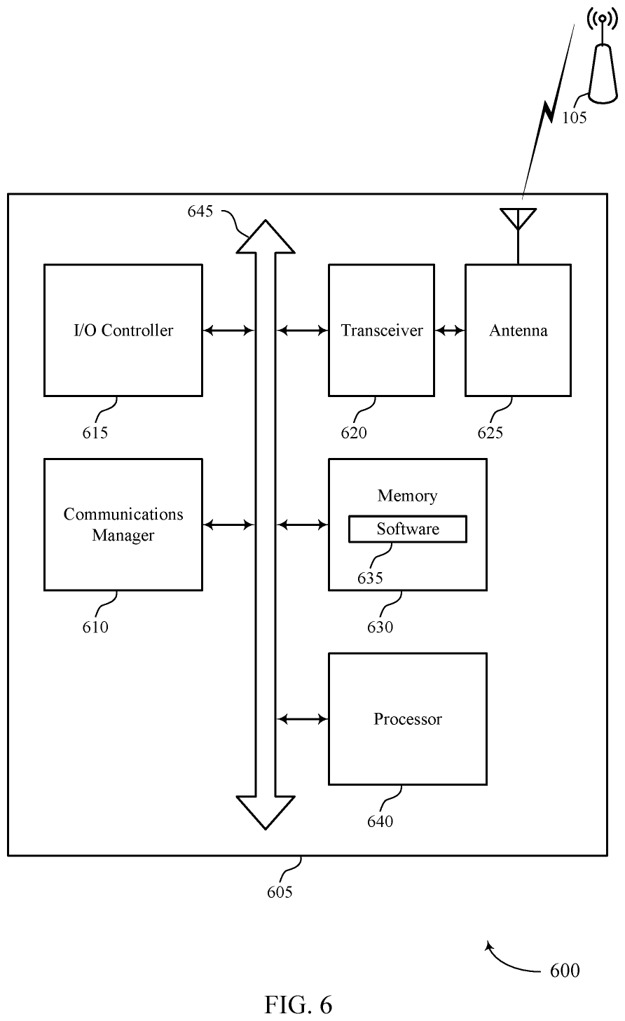

Receiver 310 may receive information such as packets, user data, or control information associated with various information channels (e.g., control channels, data channels, and information related to AP selection from a set of candidates during connection with a STA, etc.). Information may be passed on to other components of the device. The receiver 310 may be an example of aspects of the transceiver 620 described with reference to FIG. 6. The receiver 310 may utilize a single antenna or a set of antennas.

The communications manager 315 may detect one or more APs based on a scanning procedure, and sort the one or more detected APs into one or more bins based on a candidate score of each AP of the one or more APs, where each bin of the one or more bins is associated with a range of candidate scores. The communications manager 315 may select a first AP randomly from a first bin based on the sorting, where the first bin is associated with a highest range of candidate scores, and connect to the first AP based on the selecting. The communications manager 315 may be an example of aspects of the communications manager 610 described herein.

The communications manager 315, or its sub-components, may be implemented in hardware, code (e.g., software or firmware) executed by a processor, or any combination thereof. If implemented in code executed by a processor, the functions of the communications manager 315, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 315, or its sub-components, may be physically located at various positions, including being distributed such that portions of functions are implemented at different physical locations by one or more physical components. In some examples, the communications manager 315, or its sub-components, may be a separate and distinct component in accordance with various aspects of the present disclosure. In some examples, the communications manager 315, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

Transmitter 320 may transmit signals generated by other components of the device. In some examples, the transmitter 320 may be collocated with a receiver 310 in a transceiver module. For example, the transmitter 320 may be an example of aspects of the transceiver 620 described with reference to FIG. 6. The transmitter 320 may utilize a single antenna or a set of antennas.

In some examples, the communications manager 315 may be implemented by a wireless modem chip or chipset, and the receiver 310 and transmitter 320 may be implemented by analog components (such as filters, amplifiers, or antennas) coupled with the wireless modem chip or chipset to enable the receipt and transmission of wireless signals. In some examples, the communications manager 315 may be coupled to the receiver 310 over a first interface to the transmitter 320 over a second interface. Additionally, or alternatively, the receiver 310 and the transmitter 320 may share some or all of the same analog components.

The actions performed by the communications manager 315 as described herein may be implemented to realize one or more potential advantages. One implementation may allow a STA 115 to save power and increase battery life by more efficiently selecting APs for connection and potentially avoiding having to perform multiple cell connection procedures. Additionally or alternatively, communications manager 315 implementation of the described techniques may reduce the occurrence of overloaded APs. In some cases, actions performed by the communications manager 315 may result in reduced poor connection conditions, association delays, etc. and may result in more efficient use of resources (e.g., time and throughput) that the STA 115 may benefit from. For example, as other suitable APs may be selected to more efficiently or more fully balance available resources, such as bandwidth, improved quality and reliability of service may be realized at the STA 115, as latency and the number of separate resources allocated to the STA 115 may be reduced.

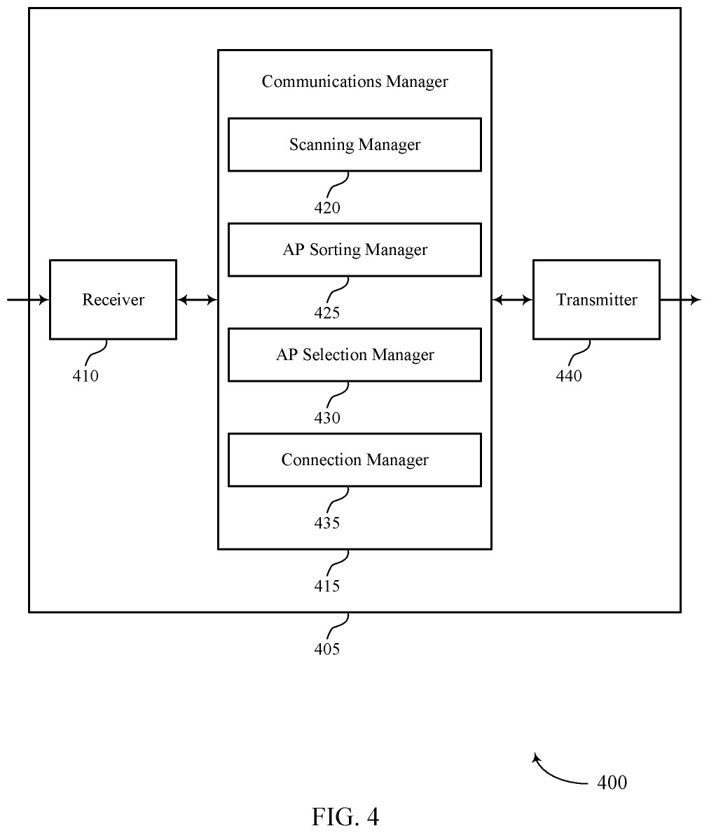

FIG. 4 shows a block diagram 400 of a device 405 that supports AP selection from a set of candidates during connection with a STA in accordance with aspects of the present disclosure. The device 405 may be an example of aspects of a device 305 or a STA 115 as described herein. The device 405 may include a receiver 410, a communications manager 415, and a transmitter 440. The device 405 may also include a processor. Each of these components may be in communication with one another (e.g., via one or more buses).

Receiver 410 may receive information such as packets, user data, or control information associated with various information channels (e.g., control channels, data channels, and information related to AP selection from a set of candidates during connection with a STA, etc.). Information may be passed on to other components of the device. The receiver 410 may be an example of aspects of the transceiver 620 described with reference to FIG. 6. The receiver 410 may utilize a single antenna or a set of antennas.

The communications manager 415 may be an example of aspects of the communications manager 315 as described herein. The communications manager 415 may include a scanning manager 420, an AP sorting manager 425, an AP selection manager 430, and a connection manager 435. The communications manager 415 may be an example of aspects of the communications manager 610 described herein.

The scanning manager 420 may detect one or more APs based on a scanning procedure. The AP sorting manager 425 may sort the one or more detected APs into one or more bins based on a candidate score of each AP of the one or more APs, where each bin of the one or more bins is associated with a range of candidate scores. The AP selection manager 430 may select a first AP randomly from a first bin based on the sorting, where the first bin is associated with a highest range of candidate scores. The connection manager 435 may connect to the first AP based on the selecting.

Transmitter 440 may transmit signals generated by other components of the device. In some examples, the transmitter 440 may be collocated with a receiver 410 in a transceiver module. For example, the transmitter 440 may be an example of aspects of the transceiver 620 described with reference to FIG. 6. The transmitter 440 may utilize a single antenna or a set of antennas.

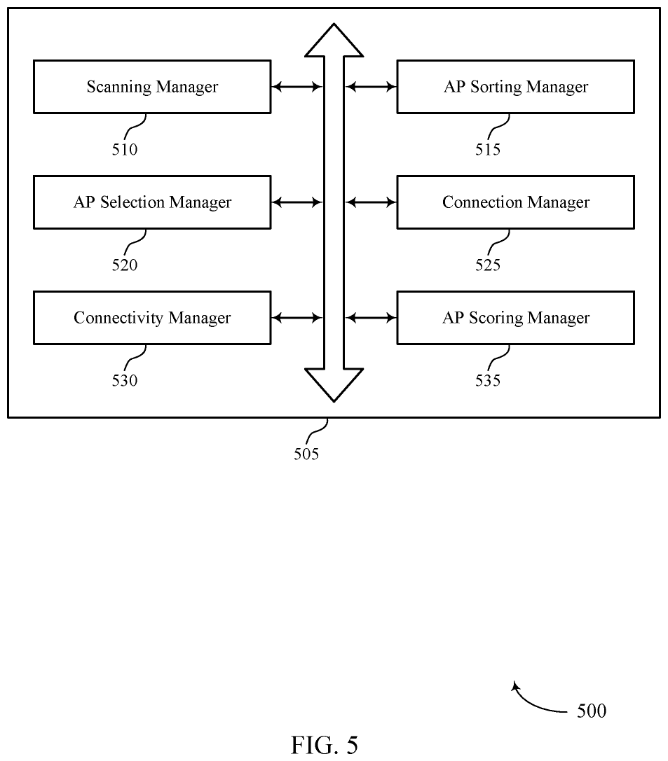

FIG. 5 shows a block diagram 500 of a communications manager 505 that supports AP selection from a set of candidates during connection with a STA in accordance with aspects of the present disclosure. The communications manager 505 may be an example of aspects of a communications manager 315, a communications manager 415, or a communications manager 610 described herein. The communications manager 505 may include a scanning manager 510, an AP sorting manager 515, an AP selection manager 520, a connection manager 525, a connectivity manager 530, and an AP scoring manager 535. Each of these modules may communicate, directly or indirectly, with one another (e.g., via one or more buses).

The scanning manager 510 may detect one or more APs based on a scanning procedure. The AP sorting manager 515 may sort the one or more detected APs into one or more bins based on a candidate score of each AP of the one or more APs, where each bin of the one or more bins is associated with a range of candidate scores. The AP selection manager 520 may select a first AP randomly from a first bin based on the sorting, where the first bin is associated with a highest range of candidate scores. The connection manager 525 may connect to the first AP based on the selecting.

The connectivity manager 530 may disconnect from the first AP based on a connectivity condition. The AP scoring manager 535 may update the candidate score for the first AP based on the connectivity condition. In some examples, the AP selection manager 520 may select a second AP randomly from the first bin based on the connectivity condition and the connection manager 525 may connect to the second AP based on the selecting.

In some examples, the AP sorting manager 515 may sort the first AP into a second bin based on the updated candidate score, where the second bin is associated with a lower range of candidate scores relative to the first bin. In some examples, the AP sorting manager 515 may determine a penalization score timer has expired. In some examples, the AP sorting manager 515 may sort the first AP into the first bin based on the candidate score for the first AP and the determination that the penalization score timer has expired. In some examples, the AP sorting manager 515 may determine the penalization score timer has expired. In some examples, the AP sorting manager 515 may sort the first AP into a third bin based on the determination that the penalization score timer has expired, where the third bin is associated with a higher range of candidate scores relative to the second bin.

In some examples, the connectivity manager 530 may determine a second connectivity condition with the first AP. In some examples, the AP sorting manager 515 may determine to blacklist the first AP for a blacklisting time duration based on the determined second connectivity condition. In some examples, the AP sorting manager 515 may determine the blacklisting time duration has expired. In some examples, the AP sorting manager 515 may sort the first AP into the first bin based on the candidate score for the first AP and the determination that the blacklisting time duration has expired. In some examples, the AP sorting manager 515 may sort the first AP into a third bin based on the determination that the blacklisting time duration has expired, where the third bin is associated with a higher range of candidate scores relative to the second bin.

In some examples, the AP scoring manager 535 may update the candidate score for the first AP based on a determination that the penalization score timer has expired. In some examples, the AP sorting manager 515 may sort the first AP from a second bin into the first bin based on the updated candidate score, where the second bin is associated with a lower range of candidate scores relative to the first bin. The AP selection manager 520 may select the first AP randomly from the first bin based on the sorting, where the first bin is associated with a highest range of candidate scores. The connection manager 525 may connect to the first AP based on the selecting.

FIG. 6 shows a diagram of a system 600 including a device 605 that supports AP selection from a set of candidates during connection with a STA in accordance with aspects of the present disclosure. The device 605 may be an example of or include the components of device 305, device 405, or a STA as described herein. The device 605 may include components for bi-directional voice and data communications including components for transmitting and receiving communications, including a communications manager 610, an I/O controller 615, a transceiver 620, an antenna 625, memory 630, and a processor 640. These components may be in electronic communication via one or more buses (e.g., bus 645).

The communications manager 610 may detect one or more APs based on a scanning procedure, sort the one or more detected APs into one or more bins based on a candidate score of each AP of the one or more APs, where each bin of the one or more bins is associated with a range of candidate scores, select a first AP randomly from a first bin based on the sorting, where the first bin is associated with a highest range of candidate scores, and connect to the first AP based on the selecting. In some cases, the communications manager 610 may be implemented as a chip or chipset of a wireless modem. Additionally, or alternatively, the communications manager 610 may be implemented with one or more of the other components of the device 605 as a system on chip (SoC).

The actions performed by the communications manager 610 as described herein may be implemented to realize one or more potential advantages. One implementation may allow a STA 115 to save power and increase battery life by more efficiently selecting APs for connection and potentially avoiding having to perform multiple cell connection procedures. Additionally or alternatively, communications manager 610 implementation of the described techniques may reduce the occurrence of overloaded APs. In some cases, actions performed by the communications manager 610 may result in reduced poor connection conditions, association delays, etc. and may result in more efficient use of resources (e.g., time and throughput) that the STA 115 may benefit from. For example, as other suitable APs may be selected to more efficiently or more fully balance available resources, such as bandwidth, improved quality and reliability of service may be realized at the STA 115, as latency and the number of separate resources allocated to the STA 115 may be reduced.

I/O controller 615 may manage input and output signals for device 605. I/O controller 615 may also manage peripherals not integrated into device 605. In some cases, I/O controller 615 may represent a physical connection or port to an external peripheral. In some cases, I/O controller 615 may utilize an operating system such as iOS®, ANDROID®, MS-DOS®, MS-WINDOWS®, OS/2®, UNIX®, LINUX®, or another known operating system. In other cases, I/O controller 615 may represent or interact with a modem, a keyboard, a mouse, a touchscreen, or a similar device. In some cases, I/O controller 615 may be implemented as part of a processor. In some cases, a user may interact with device 605 via I/O controller 615 or via hardware components controlled by I/O controller 615.

Transceiver 620 may communicate bi-directionally, via one or more antennas, wired, or wireless links as described above. For example, the transceiver 620 may represent a wireless transceiver and may communicate bi-directionally with another wireless transceiver. The transceiver 620 may also include a modem to modulate the packets and provide the modulated packets to the antennas for transmission, and to demodulate packets received from the antennas.

In some cases, the wireless device may include a single antenna 625. However, in some cases the device may have more than one antenna 625, which may be capable of concurrently transmitting or receiving multiple wireless transmissions.

Memory 630 may include RAM and ROM. The memory 630 may store computer-readable, computer-executable code or software 635 including instructions that, when executed, cause the processor to perform various functions described herein. In some cases, the memory 630 may contain, among other things, a BIOS which may control basic hardware or software operation such as the interaction with peripheral components or devices.

Processor 640 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 640 may be configured to operate a memory array using a memory controller. In other cases, a memory controller may be integrated into processor 640. Processor 640 may be configured to execute computer-readable instructions stored in a memory to perform various functions (e.g., functions or tasks supporting AP selection from a set of candidates during connection with a STA).

The software 635 may include instructions to implement aspects of the present disclosure, including instructions to support wireless communications. The software 635 may be stored in a non-transitory computer-readable medium such as system memory or other type of memory. In some cases, the software 635 may not be directly executable by the processor 640 but may cause a computer (e.g., when compiled and executed) to perform functions described herein.

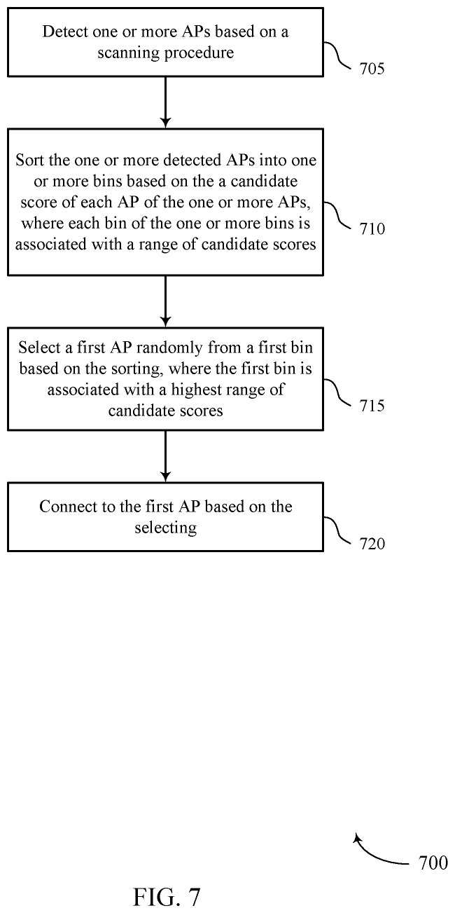

FIG. 7 shows a flowchart illustrating a method 700 that supports AP selection from a set of candidates during connection with a STA in accordance with aspects of the present disclosure. The operations of method 700 may be implemented by a STA or its components as described herein. For example, the operations of method 700 may be performed by a communications manager as described with reference to FIGS. 3 through 6. In some examples, a STA may execute a set of instructions to control the functional elements of the STA to perform the functions described below. Additionally or alternatively, a STA may perform aspects of the functions described below using special-purpose hardware.

At 705, the STA may detect one or more APs based on a scanning procedure. The operations of 705 may be performed according to the methods described herein. In some examples, aspects of the operations of 705 may be performed by a scanning manager as described with reference to FIGS. 3 through 6.

At 710, the STA may sort the one or more detected APs into one or more bins based on a candidate score of each AP of the one or more APs, where each bin of the one or more bins is associated with a range of candidate scores. The operations of 710 may be performed according to the methods described herein. In some examples, aspects of the operations of 710 may be performed by an AP sorting manager as described with reference to FIGS. 3 through 6.

At 715, the STA may select a first AP randomly from a first bin based on the sorting, where the first bin is associated with a highest range of candidate scores. The operations of 715 may be performed according to the methods described herein. In some examples, aspects of the operations of 715 may be performed by an AP selection manager as described with reference to FIGS. 3 through 6.

At 720, the STA may connect to the first AP based on the selecting. The operations of 720 may be performed according to the methods described herein. In some examples, aspects of the operations of 720 may be performed by a connection manager as described with reference to FIGS. 3 through 6.

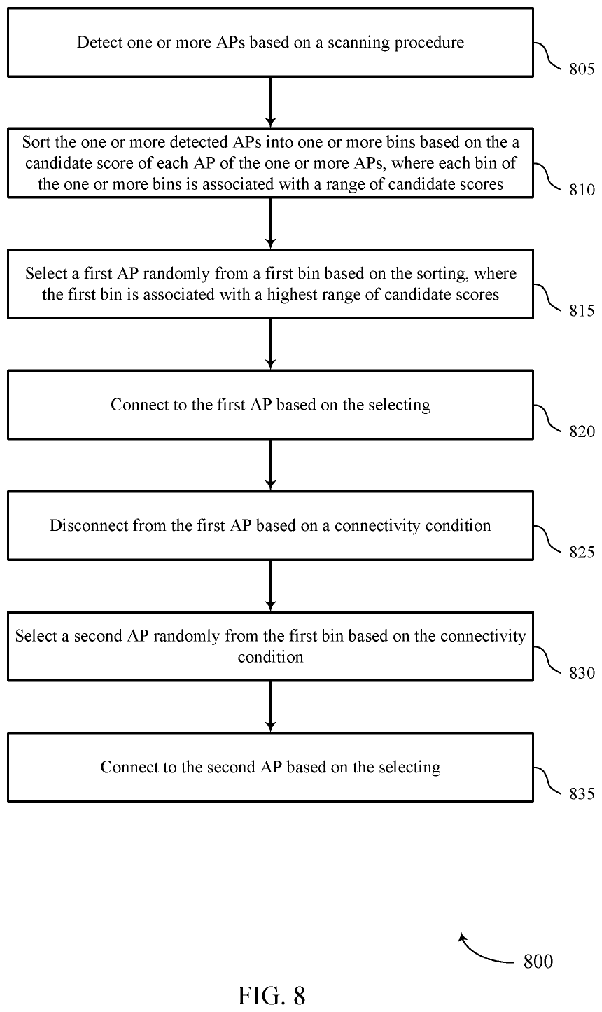

FIG. 8 shows a flowchart illustrating a method 800 that supports AP selection from a set of candidates during connection with a STA in accordance with aspects of the present disclosure. The operations of method 800 may be implemented by a STA or its components as described herein. For example, the operations of method 800 may be performed by a communications manager as described with reference to FIGS. 3 through 6. In some examples, a STA may execute a set of instructions to control the functional elements of the STA to perform the functions described below. Additionally or alternatively, a STA may perform aspects of the functions described below using special-purpose hardware.

At 805, the STA may detect one or more APs based on a scanning procedure. The operations of 805 may be performed according to the methods described herein. In some examples, aspects of the operations of 805 may be performed by a scanning manager as described with reference to FIGS. 3 through 6.

At 810, the STA may sort the one or more detected APs into one or more bins based on a candidate score of each AP of the one or more APs, where each bin of the one or more bins is associated with a range of candidate scores. The operations of 810 may be performed according to the methods described herein. In some examples, aspects of the operations of 810 may be performed by an AP sorting manager as described with reference to FIGS. 3 through 6.

At 815, the STA may select a first AP randomly from a first bin based on the sorting, where the first bin is associated with a highest range of candidate scores. The operations of 815 may be performed according to the methods described herein. In some examples, aspects of the operations of 815 may be performed by an AP selection manager as described with reference to FIGS. 3 through 6.

At 820, the STA may connect to the first AP based on the selecting. The operations of 820 may be performed according to the methods described herein. In some examples, aspects of the operations of 820 may be performed by a connection manager as described with reference to FIGS. 3 through 6.

At 825, the STA may disconnect from the first AP based on a connectivity condition. The operations of 825 may be performed according to the methods described herein. In some examples, aspects of the operations of 825 may be performed by a connectivity manager as described with reference to FIGS. 3 through 6.

At 830, the STA may select a second AP randomly from the first bin based on the connectivity condition. The operations of 830 may be performed according to the methods described herein. In some examples, aspects of the operations of 830 may be performed by an AP selection manager as described with reference to FIGS. 3 through 6.

At 835, the STA may connect to the second AP based on the selecting. The operations of 835 may be performed according to the methods described herein. In some examples, aspects of the operations of 835 may be performed by a connection manager as described with reference to FIGS. 3 through 6.

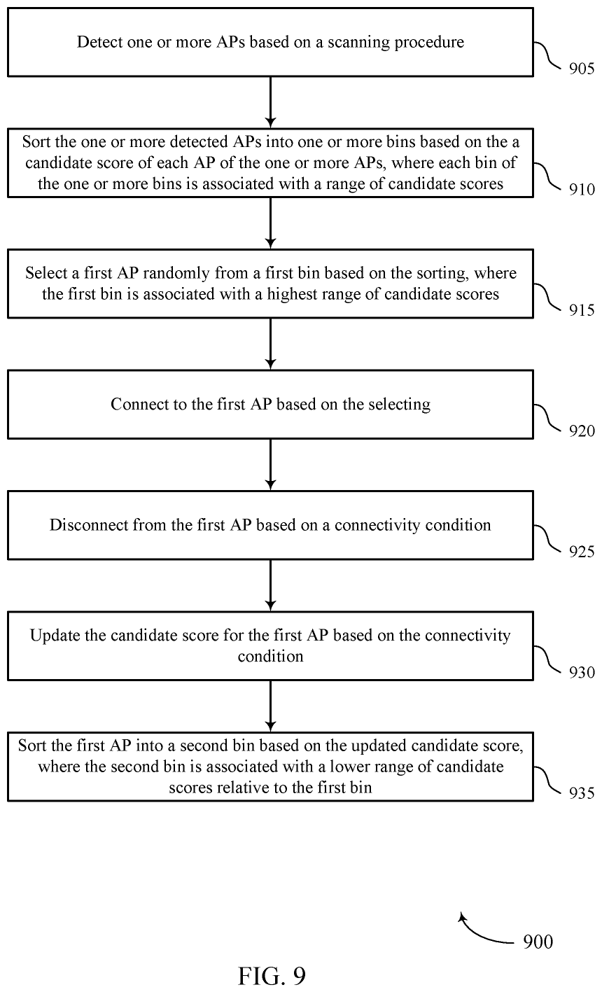

FIG. 9 shows a flowchart illustrating a method 900 that supports AP selection from a set of candidates during connection with a STA in accordance with aspects of the present disclosure. The operations of method 900 may be implemented by a STA or its components as described herein. For example, the operations of method 900 may be performed by a communications manager as described with reference to FIGS. 3 through 6. In some examples, a STA may execute a set of instructions to control the functional elements of the STA to perform the functions described below. Additionally or alternatively, a STA may perform aspects of the functions described below using special-purpose hardware.

At 905, the STA may detect one or more APs based on a scanning procedure. The operations of 905 may be performed according to the methods described herein. In some examples, aspects of the operations of 905 may be performed by a scanning manager as described with reference to FIGS. 3 through 6.

At 910, the STA may sort the one or more detected APs into one or more bins based on a candidate score of each AP of the one or more APs, where each bin of the one or more bins is associated with a range of candidate scores. The operations of 910 may be performed according to the methods described herein. In some examples, aspects of the operations of 910 may be performed by an AP sorting manager as described with reference to FIGS. 3 through 6.

At 915, the STA may select a first AP randomly from a first bin based on the sorting, where the first bin is associated with a highest range of candidate scores. The operations of 915 may be performed according to the methods described herein. In some examples, aspects of the operations of 915 may be performed by an AP selection manager as described with reference to FIGS. 3 through 6.

At 920, the STA may connect to the first AP based on the selecting. The operations of 920 may be performed according to the methods described herein. In some examples, aspects of the operations of 920 may be performed by a connection manager as described with reference to FIGS. 3 through 6.

At 925, the STA may disconnect from the first AP based on a connectivity condition. The operations of 925 may be performed according to the methods described herein. In some examples, aspects of the operations of 925 may be performed by a connectivity manager as described with reference to FIGS. 3 through 6.

At 930, the STA may update the candidate score for the first AP based on the connectivity condition. The operations of 930 may be performed according to the methods described herein. In some examples, aspects of the operations of 930 may be performed by an AP scoring manager as described with reference to FIGS. 3 through 6.

At 935, the STA may sort the first AP into a second bin based on the updated candidate score, where the second bin is associated with a lower range of candidate scores relative to the first bin. The operations of 935 may be performed according to the methods described herein. In some examples, aspects of the operations of 935 may be performed by an AP sorting manager as described with reference to FIGS. 3 through 6.

It should be noted that the methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 of FIG. 1—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a wireless station (STA), comprising:
detecting one or more access points (APs) based at least in part on a scanning procedure;
sorting the one or more detected APs into one or more bins based at least in part on a candidate score of each AP of the one or more APs, wherein each bin of the one or more bins is associated with a range of candidate scores;
selecting a first AP randomly from a first bin based at least in part on the sorting, wherein the first bin is associated with a highest range of candidate scores; and
connecting to the first AP based at least in part on the selecting.

2. The method of claim 1, further comprising:
disconnecting from the first AP based at least in part on a connectivity condition.

3. The method of claim 2, further comprising:
selecting a second AP randomly from the first bin based at least in part on the connectivity condition; and
connecting to the second AP based at least in part on the selecting.

4. The method of claim 2, further comprising:
updating the candidate score for the first AP based at least in part on the connectivity condition; and
sorting the first AP into a second bin based at least in part on the updated candidate score, wherein the second bin is associated with a lower range of candidate scores relative to the first bin.

5. The method of claim 4, further comprising:
determining a penalization score timer has expired; and
sorting the first AP into the first bin based at least in part on the candidate score for the first AP and the determination that the penalization score timer has expired.

6. The method of claim 5, further comprising:
determining the penalization score timer has expired; and
sorting the first AP into a third bin based at least in part on the determination that the penalization score timer has expired, wherein the third bin is associated with a higher range of candidate scores relative to the second bin.

7. The method of claim 4, further comprising:
determining a second connectivity condition with the first AP; and
determining to blacklist the first AP for a blacklisting time duration based at least in part on the determined second connectivity condition.

8. The method of claim 7, further comprising:
determining the blacklisting time duration has expired; and
sorting the first AP into the first bin based at least in part on the candidate score for the first AP and the determination that the blacklisting time duration has expired.

9. The method of claim 7, further comprising:
determining the blacklisting time duration has expired; and
sorting the first AP into a third bin based at least in part on the determination that the blacklisting time duration has expired, wherein the third bin is associated with a higher range of candidate scores relative to the second bin.

10. The method of claim 1, further comprising:
updating the candidate score for the first AP; and
sorting the first AP from a second bin into the first bin based at least in part on the updated candidate score, wherein the second bin is associated with a lower range of candidate scores relative to the first bin.

11. An apparatus for wireless communication at a wireless station (STA), comprising:
a processor,
memory in electronic communication with the processor; and
instructions stored in the memory and executable by the processor to cause the apparatus to:
detect one or more access points (APs) based at least in part on a scanning procedure;
sort the one or more detected APs into one or more bins based at least in part on a candidate score of each AP of the one or more APs, wherein each bin of the one or more bins is associated with a range of candidate scores;
select a first AP randomly from a first bin based at least in part on the sorting, wherein the first bin is associated with a highest range of candidate scores; and
connect to the first AP based at least in part on the selecting.

12. The apparatus of claim 11, wherein the instructions are further executable by the processor to cause the apparatus to:
disconnect from the first AP based at least in part on a connectivity condition.

13. The apparatus of claim 12, wherein the instructions are further executable by the processor to cause the apparatus to:
select a second AP randomly from the first bin based at least in part on the connectivity condition; and
connect to the second AP based at least in part on the selecting.

14. The apparatus of claim 12, wherein the instructions are further executable by the processor to cause the apparatus to:
update the candidate score for the first AP based at least in part on the connectivity condition; and
sort the first AP into a second bin based at least in part on the updated candidate score, wherein the second bin is associated with a lower range of candidate scores relative to the first bin.

15. The apparatus of claim 14, wherein the instructions are further executable by the processor to cause the apparatus to:
determine a penalization score timer has expired; and
sort the first AP into the first bin based at least in part on the candidate score for the first AP and the determination that the penalization score timer has expired.

16. The apparatus of claim 15, wherein the instructions are further executable by the processor to cause the apparatus to:
determine the penalization score timer has expired; and
sort the first AP into a third bin based at least in part on the determination that the penalization score timer has expired, wherein the third bin is associated with a higher range of candidate scores relative to the second bin.

17. The apparatus of claim 14, wherein the instructions are further executable by the processor to cause the apparatus to:
determine a second connectivity condition with the first AP; and
determine to blacklist the first AP for a blacklisting time duration based at least in part on the determined second connectivity condition.

18. The apparatus of claim 17, wherein the instructions are further executable by the processor to cause the apparatus to:
determine the blacklisting time duration has expired; and
sort the first AP into the first bin based at least in part on the candidate score for the first AP and the determination that the blacklisting time duration has expired.

19. The apparatus of claim 11, wherein the instructions are further executable by the processor to cause the apparatus to:
update the candidate score for the first AP; and
sort the first AP from a second bin into the first bin based at least in part on the updated candidate score, wherein the second bin is associated with a lower range of candidate scores relative to the first bin.

20. An apparatus for wireless communication at a wireless station (STA), comprising:
means for detecting one or more access points (APs) based at least in part on a scanning procedure;
means for sorting the one or more detected APs into one or more bins based at least in part on a candidate score of each AP of the one or more APs, wherein each bin of the one or more bins is associated with a range of candidate scores;
means for selecting a first AP randomly from a first bin based at least in part on the sorting, wherein the first bin is associated with a highest range of candidate scores; and
means for connecting to the first AP based at least in part on the selecting.
